(19) United States
(12) Patent Application Publication
(10) Pub. No.: US 2017/0155171 A1
(43) Pub. Date: Jun. 1, 2017

(54) LEAD-ACID ACCUMULATOR AND METHOD FOR MANUFACTURING SUCH AN ACCUMULATOR

(71) Applicant: COMMISSARIAT A L'ENERGIE ATOMIQUE ET AUX ENERGIES ALTERNATIVES, Paris (FR)

(72) Inventors: Angel Zhivkov KIRCHEV, Aix Les Bains (FR); Marion PERRIN, Valence (FR)

(73) Assignee: COMMISSARIAT A L'ENERGIE ATOMIQUE ET AUX ENERGIES ALTERNATIVES, Paris (FR)

(21) Appl. No.: 15/314,819

(22) PCT Filed: May 29, 2015
(86) PCT No.: PCT/FR2015/051417

§ 371 Date: Nov. 29, 2016

(30) Foreign Application Priority Data
May 30, 2014 (FR) 1454930
May 30, 2014 (FR) 1454933

(51) Int. Cl. H01M 10/12; H01M 4/16; H01M 4/38; H01M 4/56; H01M 4/36; H01M 2/26; H01M 4/68

(52) U.S. Cl. CPC H01M 10/125; H01M 2/263; H01M 4/16; H01M 4/68; H01M 4/56; H01M 4/366; H01M 4/38

(57) ABSTRACT

An electrochemical lead-acid accumulator includes negative and positive electrodes. The negative electrode has a current collector formed from a carbon sheet having a thickness between 50 and 200 μm; first and second lead-based layers respectively covering first and second faces of the carbon sheet; and first and second layers of a lead-containing active material, having a thickness between 100 and 500 μm, and arranged on either side of the carbon sheet, respectively on first and second lead-based layers. The positive electrode has a current collector formed from a titanium sheet having a thickness between 50 and 250 μm; first and second electrically conducting metal oxide layers, respectively covering first and second faces of the titanium sheet; and first and second layers of a lead-containing active material, having a thickness comprised between 100 and 500 μm, arranged on either side of the titanium sheet, respectively on first and second metal oxide layers.

### TECHNICAL FIELD

The present invention relates to an accumulator of lead-acid type used as electrochemical energy storage system, notably in the automobile field, and a method for manufacturing a lead-acid accumulator.

### STATE OF THE ART

A lead-acid accumulator comprises a positive electrode and a negative electrode immersed in a sulphuric acid-based liquid electrolyte. Each electrode conventionally comprises a lead current collector on which is arranged a lead-based active material, typically porous lead dioxide for the positive electrode and porous lead for the negative electrode. The current collector, for example in grid or plate form, serves as mechanical support to the active material and assures the electrical connection between the active material of the electrode and a terminal of the accumulator. The chemical reactions taking place in the accumulator during discharging converts the lead dioxide (PbO₂) of the positive electrode and the lead (Pb) of the negative electrode into lead sulphate (PbSO₄), and vice versa during charging.

This type of electrochemical accumulator is particularly robust, but its mass energy density (also called specific energy) is low, of the order of 30 to 40 Wh/kg. This energy density value results from the significant weight of lead current collectors and a limited use of the active materials. For example, the utilization factors of positive and negative active materials during discharge (i.e. the conversion levels of lead and lead dioxide into lead sulphate) are comprised between 30% and 50% for grid shaped current collectors and a moderate discharge current (for example Cₙ/10 h, where Cₙ is the nominal capacitance of the battery in Ah).

In order to increase the utilization factors of active materials, certain authors have proposed modifying the geometry of the electrodes, notably by reducing the thickness of the current collectors and the active material layers covering these collectors.

Thus, in the article [“Lead acid battery with thin metal film technology for high power applications”, R. C. Bhardwaj et al., J. of Power Sources 91, pp. 51-61, 2000], the positive electrode and the negative electrode each comprise a thin lead sheet (around 50 μm thick) covered on its two faces with an active material layer (around 100 μm thick). The positive and negative electrodes are wound into a spiral, with a separating sheet made of glass microfibers arranged between the two electrodes. A strip not coated with active material, corresponding to an edge of each lead sheet, projects out at each end of the spiral winding. Two cylindrical lead connectors, forming the positive and negative terminals of the accumulator, are then moulded to the two ends of the winding, over the whole length of the projecting strips.

In this lead accumulator, the utilization factors of the positive and negative active materials are greater than 80%. Nevertheless, on account of the low thickness of the lead sheets, the lifetime of the accumulator is limited. In fact, the current collector of the positive electrode is subject to a phenomenon of corrosion, the lead is gradually converted into lead dioxide. Yet, lead dioxide is fragile, which can imply a loss of dimensional stability. Furthermore, the use of voluminous lead connectors limits the mass energy density of the accumulator (of the order of 30 Wh/kg).

The energy density may be improved by replacing the lead of the positive current collector by a lighter metal, such as titanium, nickel, tin or instead molybdenum. Thus, in U.S. Pat. No. 4,326,017, a grid made of titanium (of 250 μm thickness) constitutes the current collector of the positive electrode. This grid has an electrical resistance comparable to that of a conventional lead grid, but its weight is less. The titanium grid is coated with a protective layer made of semiconductor metal oxide (for example SnO₂ doped with fluorine) and a dense layer of lead dioxide (PbO₂), before being covered with active material (of porous lead oxide PbO₂, 10 μm to 10 mm thick). The semiconductor metal oxide layer prevents contact between the sulphuric acid-based electrolyte and the titanium grid. The titanium current collector is thus protected from oxidation and the lifetime of the accumulator is enhanced. The dense layer of PbO₂ connects the active material to the current collector and reduces voltage drops in the electrode.

In combination with this positive electrode, U.S. Pat. No. 4,326,017 describes two negative electrodes each comprising a lead sheet. Due to the use of lead as negative current collector, the specific energy of such a lead accumulator is only partially improved.

Besides, patent EP2313353 describes an electrode for lead-acid battery comprising a flexible carbon sheet, having a thickness comprised between 60 μm and 180 μm, covered on its two faces with an active material layer of 200 μm to 250 μm thickness. The electrode further comprises a tie layer containing, lead and tin between the carbon sheet and each active material layer. Two electrodes of this type are wound into a spiral to form a lead-acid battery.

However, this battery shows a limited lifetime, because the positive electrode degrades over charge and discharge cycles.

Whatever the geometry proposed and the nature of the electrodes, none of the solutions proposed until now has made it possible to obtain simultaneously high mass energy density and long lifetime.

Besides, U.S. Pat. No. 4,606,982 describes a method for manufacturing a lead battery electrode. A paste of active material is firstly deposited on the two faces of a lead grid. Then, a sheet of paper made of porous material is bonded onto each face of the grid covered with paste, to form a stack of stratified layers. Each sheet of paper adheres to the grid by exerting sufficient pressure in order that the paste of active material impregnates the porous material.

To form the battery, the electrode is assembled with one or more other multilayer electrodes of opposite polarity. The two sheets of paper are made of glass microfibers and are conserved in the final structure of the battery, where they play the role of separator with the electrodes of opposite polarity.

### SUMMARY OF THE INVENTION

It therefore exists a need to provide an electrochemical lead-acid accumulator having both an extended lifetime and high specific energy.

According to the invention, this need tends to be satisfied by providing a negative electrode comprising:
a current collector formed from a carbon sheet having a thickness comprised between 50 μm and 200 μm and preferably between 130 μm and 200 μm;
first and second lead-based layers respectively covering the first and second faces of the carbon sheet; and
first and second layers of a lead-containing active material, having a thickness comprised between 100 μm and 500 μm and preferably between 300 μm and 400 μm, and arranged on either side of the carbon sheet, respectively on the first and second lead-based layers;
   and a positive electrode comprising:
a current collector formed from a titanium sheet having a thickness comprised between 50 μm and 250 μm and preferably between 100 μm and 150 μm;
first and second electrically conducting metal oxide layers, respectively covering the first and second faces of the titanium sheet; and
first and second layers of a lead-containing active material, having a thickness comprised between 100 μm and 500 μm and preferably between 130 μm and 200 μm, and arranged on either side of the titanium sheet, respectively on the first and second metal oxide layers.

Preferably, the negative electrode and the positive electrode are separated by at least one sheet of an electrically insulating porous material and held together in such a way that the porous material is compressed.

In a first embodiment, the negative electrode, the positive electrode and two sheets of porous material form a multilayer stack, said multilayer stack being wound upon itself to give the accumulator a spiral shape.

According to a development of this first embodiment, the negative and positive electrodes each comprise projecting collector portions not coated with first and second active material layers, the projecting portions of each of the negative and positive electrodes being distributed along a radius of the spiral.

In a second embodiment, one of the negative and positive electrodes comprises several electrode portions. Two sheets of porous material and the other of the negative and positive electrodes form a multilayer stack, said multilayer stack being folded into a serpentine shape to receive, under each fold, one of the electrode portions.

According to a development of this second embodiment, the negative and positive electrodes each comprise projecting collector portions not coated with first and second active material layers, the projecting portions of the negative electrode being aligned on one side of the serpentine shaped stack and the projecting portions of the positive electrode being aligned on an opposite side of the serpentine shaped stack.

The accumulator may also have one or more of the following characteristics, considered individually or according to any technically possible combinations thereof:
the first and second lead-based layers of the negative electrode have a thickness comprised between 10 μm and 20 μm;
the first and second metal oxide layers of the positive electrode have a thickness comprised between 0.5 μm and 2 μm;
each of the first and second active material layers of the negative electrode and of the positive electrode is covered with a sheet of paper made of glass fibers or cellulose-based fibers;
the negative electrode further comprises first and second copper layers arranged on either side of the carbon sheet, between each first and second lead-based layers and the carbon sheet;
the positive electrode further comprises first and second lead oxide layers arranged on either side of the titanium sheet, respectively between the first metal oxide layer and the first active material layer, and between the second metal oxide layer and the second active material layer;
the accumulator further comprises a lead connector electrically connected to a portion of the carbon sheet and a titanium connector electrically connected to a portion of the titanium sheet, the lead and titanium connectors respectively forming the negative and positive terminals of the accumulator;
the lead and titanium connectors occupy only in part a same face of the accumulator;
the carbon sheet is sheet made of graphite, flexible carbon paper or a carbon fabric; and
the titanium sheet is provided with through openings, advantageously of square section, round section or diamond-shaped.

The invention also relates to a method for manufacturing such a lead-acid accumulator comprising the following steps:
forming a negative electrode by depositing successively on each of the two faces of a carbon sheet, of thickness comprised between 50 μm and 200 μm, a lead-based layer and a layer of lead-containing active material, of thickness comprised between 100 μm and 500 μm;
forming a positive electrode by depositing successively on each of the two faces of a titanium sheet, of thickness comprised between 50 μm and 250 μm, an electrically conducting metal oxide layer and a layer of lead-containing active material, of thickness comprised between 100 μm and 500 μm; and
assembling the negative and positive electrodes with at least one sheet of an electrically insulating porous material separating the negative and positive electrodes.

According to a first embodiment, the assembly of the negative and positive electrodes comprises the following steps:
bonding, by means of the active material, a sheet made of electrically insulating porous material on each of the negative and positive electrodes;
pressing against each other the negative and positive electrodes on which are bonded the sheets made of porous material, so as to form a multilayer stack; and
winding the multilayer stack so as to compress the porous material.

Advantageously, the sheets of porous material are partially impregnated with water during the winding of the multilayer stack.

According to a second mode of implementation, the assembly of the negative and positive electrodes comprises the following steps:
bonding, by means of the active material, a sheet made of electrically insulating porous material on each of the faces of one of the negative and positive electrodes, resulting in a multilayer stack;
folding the multilayer stack into several areas;
cutting the other of the negative and positive electrodes into a plurality of electrode portions; and
arranging one electrode portion under each fold of the multilayer stack.

Preferably, the negative electrode and the positive electrode are, during the assembly step, distributed in the form of continuous and flexible strips, driven by rotating cylinders and shaped in parallel with each other.

The shaping of the negative and positive electrodes may comprise a step of brushing and a step of cutting up a portion of the carbon sheet and a portion of the titanium sheet, so as to form connecting straps on each of the negative and positive electrodes, said portions being free of active material.

Preferably, the formation of each of the negative and positive electrodes of the lead accumulator comprises the following steps:
providing first and second sheets of pasting paper and a current collecting sheet, the current collecting sheet of the negative electrode being constituted of the carbon sheet covered on each of the two faces of the lead-based layer and the current collecting sheet of the positive electrode being constituted of the titanium sheet covered on each of the two faces of the electrically conducting metal oxide layer;
depositing active material on each of the first and second sheets of pasting paper; and
bonding simultaneously, by means of the active material, the first sheet of pasting paper onto a first face of the current collecting sheet and the second sheet of pasting paper onto a second opposite face of the current collecting sheet.

The formation of an electrode may also have one or more of the following characteristics, considered individually or according to any technically possible combinations thereof:
the current collecting sheet is in vertically oriented strip form and each of the first and second sheets of pasting paper is brought into contact with the current collecting sheet along a direction perpendicular to the current collecting sheet;
the first and second sheets of pasting paper are in strip form, each strip being carried by a belt conveyor during the step of depositing the active material;
the first and second sheets of pasting paper move at a speed comprised between 5 cm/s and 1 m/s and preferably between 5 cm/s and 50 cm/s;
the first and second sheets of pasting paper are bonded to the current collecting sheet using two calendaring cylinders exerting a pressure on either side of the current collecting sheet;
each of the negative and positive electrodes is moreover laminated by means of two laminating cylinders arranged on either side of the current collecting sheet;
the first and second sheets of pasting paper have a thickness comprised between 20 μm and 200 μm;
the active material is spread out on each of the first and second sheets of pasting paper by means of a spreading cylinder and smoothed by means of a scraper;
the active material is deposited in beads on each of the first and second sheets of pasting paper by means of a plurality of coating nozzles and spread out during the bonding step by pressing said sheet of pasting paper against the current collecting sheet.

### BRIEF DESCRIPTION OF THE FIGURES

Other characteristics and advantages of the invention will become clear from the description that is give thereof hereafter, as an indication and in no way limiting, and by referring to the appended figures, among which:

FIG. 1 is a transversal sectional view of a negative electrode for a lead accumulator according to the invention;

FIG. 2 is a transversal sectional view of a positive electrode for a lead accumulator according to the invention;

FIGS. 3A and 3B represent a first embodiment of a lead accumulator according to the invention, in which the negative and positive electrodes of FIGS. 1 and 2 are wound into spirals;

FIG. 4 is a frontal view of the negative electrode of FIGS. 3A and 3B, arranged in the form of a strip before winding into a spiral;

FIG. 5 represents a second embodiment of a lead accumulator according to the invention, in which the negative and positive electrodes of FIGS. 1 and 2 are assembled in a prismatic cell;

FIG. 6 represents a front view of the negative electrode and the positive electrode of FIG. 5, before they are respectively folded and cut to be assembled in the form of FIG. 5;

FIGS. 7, 8A and 8B represent a first electrical connector fixed to the projecting connecting elements of a negative electrode and forming the negative terminal of a lead accumulator;

FIG. 9 represents a second electrical connector, forming the positive terminal of a lead accumulator;

FIGS. 10A and 10B represent two modes for attaching the connector of FIG. 9 to the projecting connection elements of a positive electrode;

FIG. 11 represents a preferential embodiment of a method for manufacturing an electrode, of “roll-to-roll” type;

FIGS. 12A to 12C represent an alternative embodiment of the step of pasting the electrode of FIG. 11; and

FIG. 13 represents a preferential embodiment of the step of assembly of a spiral accumulator, of “roll-to-roll” type.

### DETAILED DESCRIPTION OF AT LEAST ONE EMBODIMENT

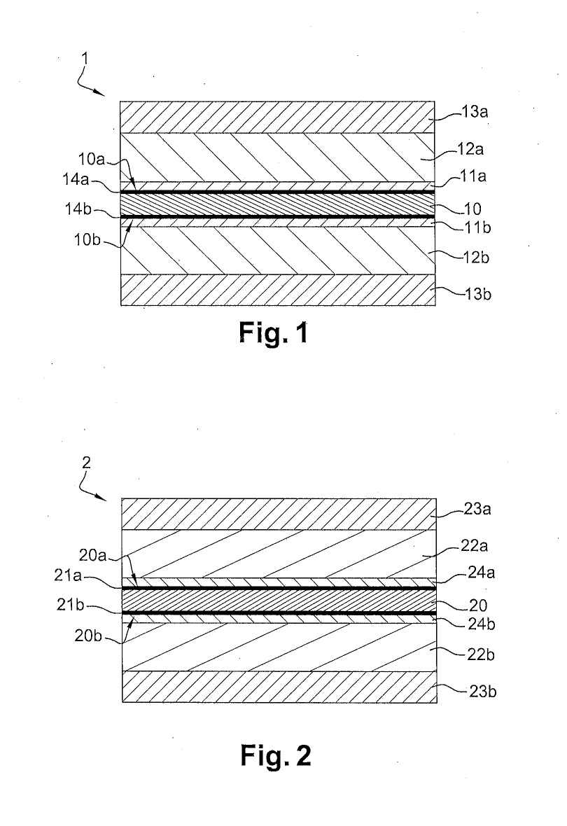

FIGS. 1 and 2 represent respectively a negative electrode 1 and a positive electrode 2 of a lead-acid accumulator having high energy density (or specific energy) and high power density (or specific power).

Each electrode is constituted of a multilayer stack constructed in a symmetrical manner around a current collector having the shape of a sheet, that is to say a thin and flexible plate. This sheet constitutes the support for two layers of active material, hereafter called negative active material (NAM) for the negative electrode and positive active material (PAM) for the positive electrode. An active material layer covers each side of the sheet.

In the negative electrode 1 of FIG. 1, the current collector 10 is based on carbon. It is, preferably, formed from a sheet made of vitreous carbon or graphite, as opposed to carbon foams which contain in general an important volume of pores. Alternatively, it may be constituted of carbon or graphite fibers, in the form of a flexible paper (i.e. the fibers are cut and maintained by a binder—they are not woven) or a fabric (i.e. the fibers are woven). The thickness of the carbon collector 10 is comprised between 50 μm and 200 μm, and preferably comprised between 130 μm and 200 μm. As an example, a graphite sheet (also known as “graphite foil”) may have a density of the order of 1 g·cm⁻³ to 2 g·cm⁻³. The carbon sheet 10 furthermore has a thermal conductivity ten times greater than that of lead, which makes it possible to use the accumulator in high power applications.

The carbon sheet 10 comprises two main and parallel faces 10a and 10b, each coated with a thin layer made of lead or a lead alloy (for example lead and tin). A first lead-based layer 11a is thus arranged on the face 10a and a second lead-based layer 11b is arranged on the face 10b. The layers 11a and 11 b enable a better hold of the negative active material, also lead-based, on the current collector 10. Moreover, they improve the electrical conductivity and the mechanical strength of the carbon collector 10. Preferably, the layers 11a and 11b cover the whole surface of the carbon sheet 10 and their thickness is comprised between 10 μm and 20 μm, such that they are free of holes.

The negative electrode 1 of FIG. 1 further comprises two layers of negative active material (NAM) 12a and 12b arranged respectively on the lead-based layers 11a and 11b. The layers of NAM 12a and 12b have a thickness comprised between 100 μm and 500 μm, and preferably between 300 μm and 400 μm. Thicker layers 12a and 12b would make the electrode less flexible and would make its assembly with the positive electrode to form an electrochemical cell more complex, whereas a lower thickness would cause lesser utilization of the active material. The negative active material is, preferably, porous lead.

Two sheets 13a and 13b of paper, made of glass fibers (of around 100 μm thickness) or cellulose-based fibers (of around 50 μm thickness), may be arranged on either side of the carbon sheet 10 on the active material layers 12a and 12b. The sheets 13a and 13b prevent the active materials layers 12a and 12b from cracking during the assembly of the electrodes and chipping during the operation of the accumulator.

Advantageously, the negative electrode 1 comprises two intermediate copper layers 14a and 14b, having preferably a thickness comprised between 5 μm and 10 μm, and arranged on either side of the carbon sheet 10, between each of the lead-based layers 11a-11b and the carbon sheet 10. These copper layers 14a, 14b considerably improve the electrical conductivity of the carbon sheet 10, with a minimum of additional weight given their low thickness.

The positive electrode 2, represented in FIG. 2, comprises a titanium sheet 20 of thickness comprised between 50 μm and 250 μm, and preferably comprised between 100 μm and 150 μm. This sheet 20 may be solid (i.e. not pierced) or provided with through openings, for example of square section, round section or diamond-shaped (in the latter case, it is known as “expanded titanium foil”). The size of the openings (i.e. their side or diameter) is advantageously comprised between 50 μm and 250 μm (for the diamond shaped section, the median of the two diagonals of the diamond is considered). The titanium constituting the sheet 20 is, preferably, more than 99% pure (grade 1 and/or grade 2). It is thus soft and ductile, facilitating its implementation in the lead accumulator as current collector of the positive electrode.

Each of the two faces 20a and 20b of the titanium sheet 20 is coated with an electrically conducting metal oxide layer, respectively 21a and 21b, for example made of tin dioxide SnO₂. The layers 21a and 21b cover, preferably, the current collector 20 completely. They constitute artificial corrosion layers and protect the titanium from oxidation, thus avoiding the formation of an electrically resistant titanium oxide TiO₂ and which is slightly soluble in the electrolyte. Thus, the titanium current collector 20 subjected to positive potentials can withstand the electrolyte longer.

The metal oxide is, preferably, a semiconductor doped with fluorine (F), antimony (Sb) or ion's of a transition metal, in order to increase its electrical conductivity. Its thickness in the layers 21a and 21b is advantageously comprised between 0.5 μm and 2 μm, in order that they contain a minimum of defects.

Two layers of positive active material (PAM) 22a and 22b are arranged on either side of the titanium sheet 20 coated with the semiconductor metal oxide 21a-21b. The layer 22a covers the metal oxide layer 21a and the layer 22b, situated on the other side of the electrode with respect to the titanium sheet 20, covers the layer 21b. Like the layers of NAM 12a and 12b, the layers of PAM 22a and 22b have a thickness comprised between 100 μm and 500 μm, and preferably between 130 μm and 200 μm. The positive active material of the layers 22a and 22b is, preferably, porous lead dioxide (PbO₂).

Like the negative electrode 1, each of the layers 22a and 22b made of PbO₂ of the positive electrode 2 may be covered with a sheet of paper made of glass fibers or cellulose-based fibers. These layers respectively bear the references 23a and 23b in FIG. 2.

Finally, the positive electrode 2 advantageously comprises two dense layers of lead dioxide 24a and 24b (i.e. without pores, unlike the layers of PAM). These layers 24a and 24b of PbO₂, of which the thickness is comprised between 5 μm and 20 μm, are arranged on either side of the titanium sheet 20, respectively between the semiconductor metal oxide layer 21a and the layer of PAM 22a, and between the semiconductor metal oxide layer 21b and the layer of PAM 22b. Thanks to these layers 24a and 24b, the PAM material better adheres to the titanium current collector 20 (covered with artificial corrosion layers 21a-21b).

Thus, the negative electrode comprises a current collector formed from a carbon sheet, coated on each of its two faces with a lead-based layer, then a layer of a lead-containing active material having a thickness comprised between 100 μm and 500 μm. Similarly, the positive electrode is formed from a titanium sheet coated successively on its two faces with an electrically conducting metal oxide layer and a layer of a lead-containing active material having a thickness comprised between 100 μm and 500 μm.

Thanks to these particular configurations of electrodes, the utilization factors of the positive and negative active materials are particularly high, of the order of 90%. This is due in part to the low occupation rate of the active materials on the current collectors (expressed in mass of active material per surface unit). In fact, given the thicknesses of the active material layers and the geometry of the current collectors, this occupation rate, also called coefficient γ, is less than 0.5 g/cm² for each of the positive and negative electrodes. Moreover, the mass ratio of the active material to the current collector has a high value, comprised between 3 and 7 for each of the electrodes.

The aforementioned utilization factors and mass ratios procure, after assembly of the negative and positive electrodes, high values of energy and power mass densities, respectively of around 60 Wh/kg to 90 Wh/kg and around 1 kW/kg to 10 kW/kg. As a comparison, the energy density of an accumulator comprising thin lead collectors, as described in the article [“Lead acid battery with thin metal film technology for high power applications”, R. C. Bhardwaj et al., J. of Power Sources 91, pp. 51-61, 2000], is below 30 Wh/kg.

Besides, each of the electrodes is designed to withstand corrosion by the electrolyte. The negative current collector made of carbon is insensitive to the sulphuric acid electrolyte under negative potentials whereas the positive current collector is protected over its whole surface in contact with the electrolyte by the semiconductor metal oxide layers. This guarantees a long lifetime to the lead accumulator comprising these two electrodes.

Moreover, the charge acceptance (synonymous with the charge efficiency) and the discharge capacitance at high current of the accumulator are high, because the positive and negative electrodes are thin compared to those of conventional lead batteries. These high electrical performances are mainly due to rapid diffusion of sulphate ions through the active material layers and low electrical resistance of the active material layers. Preferably, the total thickness of the electrodes does not exceed 0.8 mm.

To form a lead accumulator, the negative and positive electrodes of FIGS. 1 and 2 are joined, while interposing between them at least one sheet of an electrically insulating porous material. This porous material is intended to contain the electrolyte of the accumulator, typically sulphuric acid, and to insulate electrically the two electrodes.

The electrodes are advantageously assembled in such a way that the porous material of the separating sheet is compressed. This compression is measured by a reduction in the thickness of the separating sheet of around 20%. It makes it possible to further increase the lifetime of the accumulator, the active materials being less likely to soften and to chip over time. Several forms of assembly of the negative and positive electrodes may be envisaged.

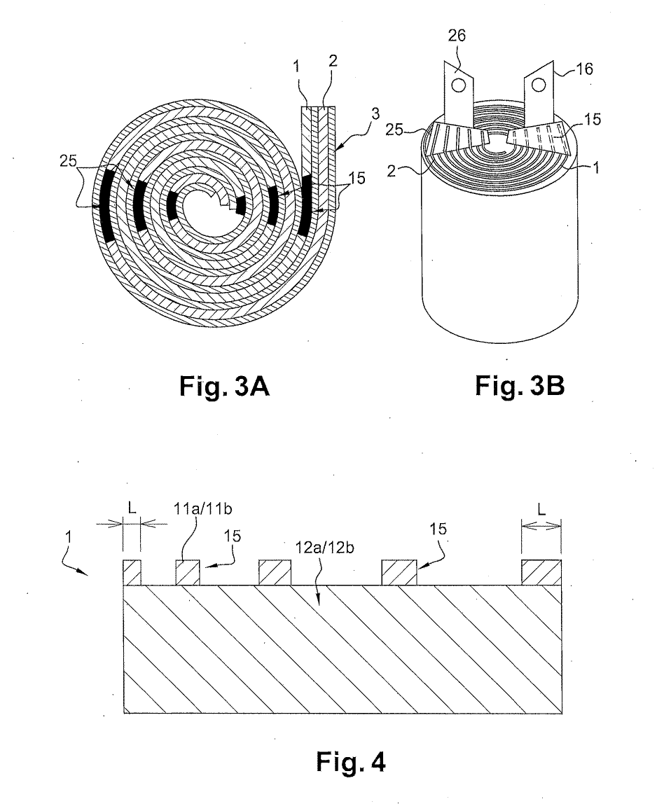

According to a first embodiment represented by FIGS. 3A and 3B, respectively in top view and perspective view, the negative 1 and positive 2 electrodes are stacked with two separator sheets 3 formed from the porous and insulating material. This multilayer stack is wound upon itself to give the accumulator a spiral shape.

The sheets 3 are arranged such that at any point of the winding, one of them separates the negative 1 and positive 2 electrodes. Thus, no short-circuit between the electrodes 1 and 2 is possible and the utilization factor of the electrolyte is maximal. The two separator sheets 3 are for example arranged on either side of the positive electrode 2 in FIG. 3A.

The separator sheets 3 are, preferably, of AGM (Adsorptive Glass Mat) type, that is to say microporous glass fibers layers. This type of separator is commonly employed in valve regulated lead acid (VRLA) batteries to store the electrolyte and maintain the active material on the electrodes. The sheets 3 have, preferably, a thickness (before compression) of the order of 2 mm for a high energy density battery. For a high power density battery, the thickness of the sheets 3 is advantageously comprised between 0.8 mm and 1 mm. In both cases, the separator sheets 3 can store a sufficient volume of electrolyte to reach utilization factors of active materials (positive and negative) of around 90%.

The spiral accumulator of FIGS. 3A and 3B further comprises two series of projecting connecting straps, for example on the side of the upper face of the stack. Each series of straps enables the fixation of an electrical connector, preferably in metal. The straps 15 belong to the negative electrode 1 (FIG. 3A) and are fixed to a connector 16 (FIG. 3B), whereas the straps 25 belong to the positive electrode 2 and are fixed to a connector 26. Thus, each of the connectors 16, 26 electrically connect in parallel the connecting straps 15, 25.

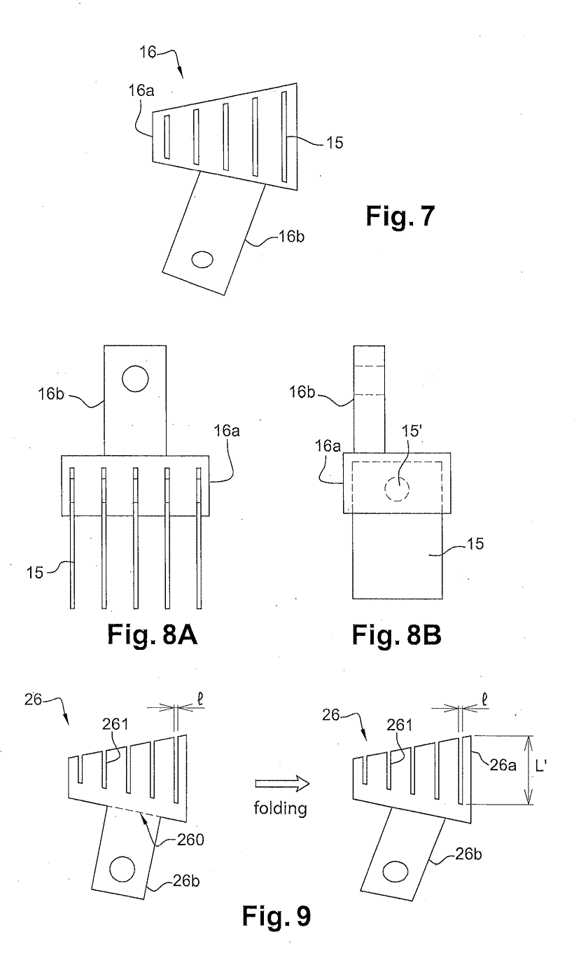

The connectors 16 and 26 form respectively the negative and positive terminals, which extend up to outside of the accumulator. They will be described in detail in relation with FIGS. 7, 8A-8B, 9 and 10A-10B.

The connecting straps of each electrode assure the transport of the electrical current between the collector of this electrode and the corresponding electrical terminal of the accumulator. They are advantageously aligned and distributed along a radius of the spiral, as is represented in FIG. 3A. This configuration of the straps simplifies the geometry of the connectors 16, 26 and facilitates their fixation to the spiral stack.

FIG. 4 represents an arrangement of the connecting straps 15 of the negative electrode 1 before its assembly with the positive electrode 2. Preferably, the straps 15 are each constituted of a projecting portion of the carbon sheet coated with lead-based layers 11a and 11b. They extend on a same side of the electrode 1 and, unlike the remainder of the electrode, they are not covered with active material layers 12a and 12b.

The connecting straps 15 are advantageously spaced two by two apart by a distance that varies while increasing in looking from left to right in FIG. 4. More precisely, the spacing between the straps 15 is chosen such that after winding of the electrode 1 with the electrode 2 and the separators 3, the straps 15 are aligned. Moreover, the length L of the straps 15 increases as one moves away from the centre of the spiral (FIG. 3), i.e. at the same time as the increase in their spacing (FIG. 4). It is thus aimed to obtain a positioning of the straps in a cone, which has as big an angle as possible, for example 90°. This makes it possible to obtain a ratio between the sum of the lengths L of the straps 15 and the total width of the electrode much greater than that of a prismatic configuration, giving rise to higher injection of current and thus greater power (at least 3 times more than that of a prismatic cell).

In the embodiment represented in FIGS. 3A, 3B and 4, the spacing of the straps 15 is such that each strap is positioned in a centred manner on the same radius of the spiral, with each turn of spiral. This layout of the straps 15 is particularly suited to high power electrochemical cells, which require a large number of these connection elements 7) in order to better distribute the current. In an alternative embodiment (not represented) intended for accumulators of lower current density, it is wished that a strap appears only one turn out of two and the spacing may be chosen as a consequence.

The connecting straps 25 of the positive electrode 2 are each constituted of a portion of the titanium current collector covered with metal oxide layers, but not coated with active material. They are, preferably, arranged in the same way as the straps 15.

As an example, the lead accumulator comprises a negative electrode of the type of FIG. 1 and a positive electrode of the type of FIG. 2, stacked with two AGM separators of 2 mm thickness. The electrodes have, without taking account of the connecting straps, a rectangular surface area equal to 10 cm×150 cm. Each electrode thus exposes a surface area of active material of the order of 3000 cm². The wound stack occupies a cylinder of 10.5 cm diameter and 10 cm high, which corresponds approximately to 8 winding turns. The number of straps of each electrode is equal to 7. The winding of electrodes and separators is arranged in a cylindrical case, of around 11 cm diameter and 12 cm height, closed by a cover. The case and cover, both made of polypropylene, have walls around 2.5 mm thick. A lead connector and a titanium connector respectively form the negative and positive terminals of the accumulator. The remaining volume of the cylindrical case is filled with a solution having a sulphuric acid concentration (in the completely charged state) of 5 mol/L and a specific gravity of 1.285 g/mL.

Table 1 below lists the components of this spiral accumulator and gives, for each of them, its thickness and its weight. It will be noted that the thickness values indicated in the table concern the thickness of a single example of the component, and not the total thickness of several examples of a same component (if several examples exist). On the other hand, the weight values represent the total weight of all the examples of a same component taken together. These remarks are valid for the layers of NAM, PAM, Pb, PbO₂ and AGM (2 examples each).

TABLE 1

| | | | | | | Capaci- | |
|---|---|---|---|---|---|---|---|
| | | | | | | tance | |
| Component | Thickness | | Weight | | Use | (Ah) | Energy (Wh) |
| NAM | 300 | μm | 360 | g | 90% | 83.9 | 168 |
| PAM | 350 | μm | 441 | g | 85% | 84.0 | |

| | | | | | |
|---|---|---|---|---|---|
| 5M H₂SO₄ | — | 892 | g | 90% | 83.7 |

| Ti sheet | 50 | μm | 34 | g | Total surface area: 3000 cm² |
|---|---|---|---|---|---|
| PbO₂ coating | 15 | μm | 43 | g | On the two faces |
| Graphite | 100 | μm | 18 | g | Total surface area: 3000 cm² |
| sheet | | | | | |
| Pb coating | 15 | μm | 51 | g | On the two faces |
| Case + cover | 2.5 | mm | 124 | g | Polypropylene; |
| | | | | | Ø = 11 cm/h = 12 cm |
| Ti connector | — | | 22 | g | On 7 connecting straps |
| Pb connector | — | | 187 | g | On 7 connecting straps |
| AGM | 2.2 | mm* | 120 | g | 2 mm AGM + 2 × 0.1 mm |
| [400 g/m²] | | | | | glass fibers paper |

| | | | | |
|---|---|---|---|---|
| Total weight | 2292 | g | 73 | Wh/kg |
| Cell volume | 1140 | mL | 147 | Wh/L |

Concerning the negative electrode, the current collector is a graphite sheet of thickness equal to 100 μm and its specific gravity is of the order of 1.2 g/cm³. The layers of negative active material (NAM) are constituted of lead in the pure state (4 g/cm³) and have a thickness of 300 μm. The galvanic lead coatings on the carbon collector have a thickness of 15 μm and the layers of paper have a thickness of 100 μm (the layers of paper are assimilated with the AGM in table 1). For this negative electrode, the occupation rate of the negative active material γ_{NAM} is equal to around 0.12 g/cm² (compared to values ranging from 2 to 2.5 g/cm² for grid collectors of the prior art) and the ratio of the mass of NAM to the mass of collector is around 7:1.

The details concerning the positive electrode are the following:
a titanium sheet of 50 μm thickness (specific gravity equal to 4.5 g/cm³);
two layers of SnO₂ doped with antimony of 2 μm thickness;
two layers of PbO₂ doped with fluorine each having a thickness of 15 μm;
two layers of PAM (PbO₂) of 350 μm thickness (specific gravity equal to 4.2 g/cm³);
two sheets of paper made of glass fibers of 100 μm thickness;

The occupation rate of the positive active material γ_{PAM} is equal to around 0.15 g/cm² and the PAM/collector mass ratio is around 7:1.

Apart from utilization factors for the negative and positive active materials, table 1 above gives the capacitances (expressed in Ah) relative to each active material and to the electrolyte, as well as the energy (expressed in Wh) developed by the combination thereof. The latter is, in the final lines of table 1, compared to the total weight and volume of the cell to give respectively the mass energy density and the volume energy density.

According to table 1, this example of spiral accumulator shows utilization factors of NAM and PAM respectively of 90% and 85%, resulting in an energy density of 73 Wh/kg (by mass) or 147 Wh/L (by volume), i.e. two times more than accumulators of the prior art. Moreover, when the accumulator is discharged with a current equal to 30*Cₙ/h (where Cₙ is the nominal capacitance of the accumulator in Ah), the power density delivered by the accumulator is close to 2 kW/kg (or 4 kW/L).

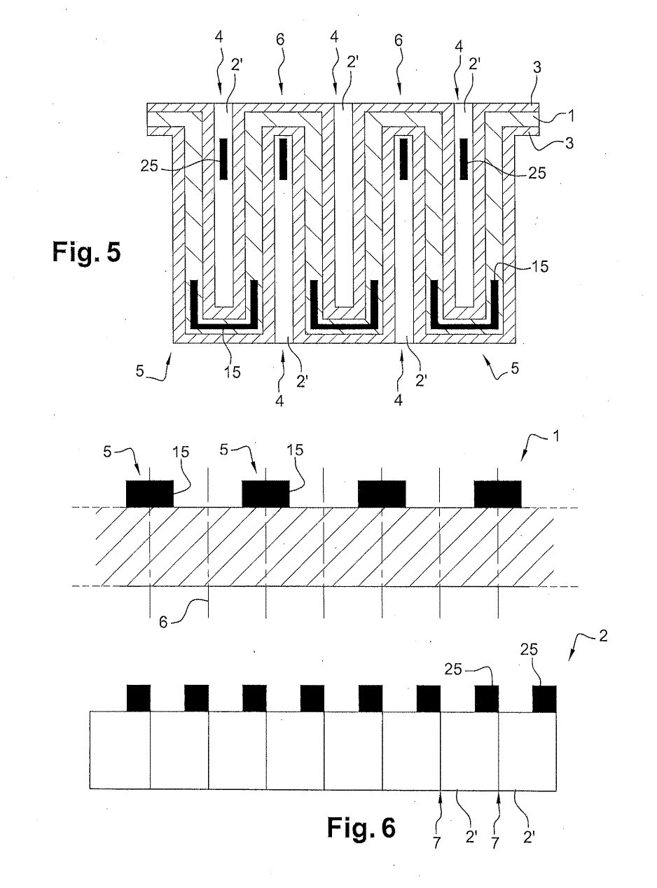

FIG. 5 represents, in top view, a second embodiment of a lead accumulator, in which the electrodes 1 and 2 are assembled in an undulating shape, in the manner of a serpentine shape. The electrochemical accumulator thus configured is like a prismatic cell, where the positive and negative electrode(s) are lined up in parallel with each other in a parallelepiped case.

One of the positive and negative electrodes, here the negative electrode 1, is arranged between two separator layers 3, preferably of AGM type. The multilayer stack thereby obtained is folded into a serpentine shape, that is to say in a repeating manner and in opposing senses from one fold 4 to the other. Under each fold 4 is arranged a portion 2′ of positive electrode. These portions 2′ are for example obtained after cutting up a positive electrode 2 of larger dimensions.

The electrodes of the accumulator also have, in this second embodiment, projecting straps or connection elements 15 and 25. These straps extend in a direction parallel to the fold lines of the negative electrode 1, perpendicularly to the plane of FIG. 5.

The straps of each electrode may be, here as well, aligned to facilitate the design and fitting of connectors (not represented). For example, the straps 15 of the continuous negative electrode 1 extend above the folding areas 5 of the stack 3-1-3, these areas 5 being situated on the same side of the serpentine shaped assembly. The straps 25 of the positive electrode, which is “exploded” into several portions 2′, are situated on the opposite side of the assembly, in the immediate proximity of the folding areas 6. The areas 6 result from the folding of the stack in a sense opposite to that of the areas 5.

Of course, the configuration of FIG. 5 may be reversed. The positive electrode 2 is then stacked with the AGM separators 3, then folded, and the negative electrode 1 is subdivided into a plurality of portions arranged under the folds of the positive electrode 2.

FIG. 6 represents the electrodes 1 and 2 before their assembly in the form of FIG. 5, and more particularly the arrangement of their connecting straps 15 and 25.

The electrodes 1 and 2 are in strip form, that is to say long and narrow. Their composition is identical to that described in relation with FIG. 1 or 2. As mentioned previously, the straps 15 and 25 are formed from portions of the current collector (respectively made from carbon and titanium), projecting from a same side of the electrode and not covered by the layers of active material (NAM and PAM respectively). Thus, compared to the configuration of the electrodes in FIG. 4, only the spacing and the dimensions of the straps 15 and 25 differ.

On the negative electrode 1, the straps 15 are situated at the level of the folding areas 5 of the electrode, shown schematically by dotted lines in FIG. 6. They are, preferably, centred on these folding lines 5. Moreover, two successive straps 15 are separated by a folding area 6, also reduced to a dotted line. In other words, there are no straps 15 in the folding areas 6, as is also visible in FIG. 5.

The positive electrode 2 is represented in FIG. 6 before its cutting into portions 2′. The electrode portions 2′ are delimited by cut-out lines 7. Preferably, they have the same size and each has a connecting strap 25.

In this second embodiment, the straps 15 of the negative electrode 1 on the one hand, and the straps 25 of the negative electrode 2 on the other hand, are regularly spaced apart along the strips 1 and 2 (like the folding lines 5 and 6). All the straps 15 of the negative electrode 1 have the same size, unlike those of FIG. 4. Similarly, the positive electrode straps 25 are all identical, their surface being for example equal to half of that of a negative electrode strap 15.

Compared to a spiral accumulator, the prismatic accumulator has the advantage of being more compact (the energy volume density is slightly greater). Nevertheless, maintaining the compression in this configuration requires a case with mechanically reinforced lateral walls, which makes it heavier (resulting in a lower mass energy density than in the spiral accumulator).

FIGS. 7 and 9 represent preferential embodiments of electrical connectors 16 and 26, forming respectively the negative and positive terminals of the accumulator. These terminals connect the negative and positive electrodes (and more particularly their current collector) to an external electrical circuit, for example a charge to supply with energy.

The connectors 16 and 26, which are described in relation with these figures, are compatible with the lead accumulator according to the invention whatever its configuration—for example spiral or prismatic shaped. Their composition and their technique of elaboration vary, because the nature of the current collector to which they are fixed differs depending on whether said collector belongs to the positive electrode or the negative electrode.

The negative connector 16 of FIG. 7 is, preferably, formed from a single part made of lead obtained by a method of moulding around the connecting straps 15 of the negative electrode (method called “Cast-On-Strap”, COS). The choice of lead as material guarantees a solid fixation of the connector 16 to the connecting straps 15, which are also covered with lead (layers 11a-11b).

During this “COS” method, the cylindrical accumulator is turned over in order that the connecting straps 15, arranged projecting parallel to each other, are placed in a mould. The mould is filled with a molten metal, here lead, then cooled in order to release the moulded part. The mould contains the final shape of the negative connector 16, represented in FIG. 7.

FIGS. 8A and 8B are other views of the negative connector 16 of FIG. 7, respectively facing and side views, showing more clearly the connecting straps 15 of the negative electrode.

The connector 16 comprises a first flat portion 16a moulded around straps 15 and a second flat portion 16b, in the extension of the first portion 16a. As is apparent in FIGS. 8A and 8B, the straps 15 extend perpendicularly to the plane of the portion 16a. The thickness of the portion 16a is advantageously comprised between 5 mm and 20 mm. The second flat portion 16b also extends in a direction perpendicular to the plane of the portion 16a, but in a sense opposite to that of the straps 15. Its thickness is advantageously comprised between 5 mm and 15 mm. In the finalised accumulator, the portion 16b of the connector 16 exits the case and constitutes the negative terminal of the accumulator.

Advantageously, the connecting straps 15 each comprise a hole 15′, such that during the moulding step, said hole is filled with lead. This reinforces the mechanical and electrical connections between the straps 15 and the connector 16.

The current collector of the positive electrode being made of titanium, the positive connector 26 of FIG. 9 is advantageously formed from titanium, ideally of the same quality (grade 1 and/or 2). The connector 26 is, for example, obtained by punching of a titanium sheet having a thickness comprised between 0.5 mm and 3 mm, depending on the power of the accumulator (a high thickness is provided in the case of high electrical capacitance and high electrical power, and vice-versa).

The connector 26 comprises a first portion 26a and a second portion 26b, which, after folding the titanium sheet along the axis 260 represented in dotted lines, extends perpendicularly to the portion 26a. The portion 26a comprises notches 261 intended to receive the connecting straps of the positive electrode. To this end, the notches 261 have a width noted “I” slightly greater than the thickness of the straps and their length “L” corresponds substantially to the length “L” of the straps (FIG. 4). Their shape may be rectilinear, as is represented in FIG. 9 or arc of circle shaped, in the case of the spiral accumulator for example (the radius of curvature of the notches 261 then corresponds to the radius of curvature of each strap, cf. FIGS. 3A-3B). The notches 261 are, preferably, arranged parallel to each other in the portion 26a.

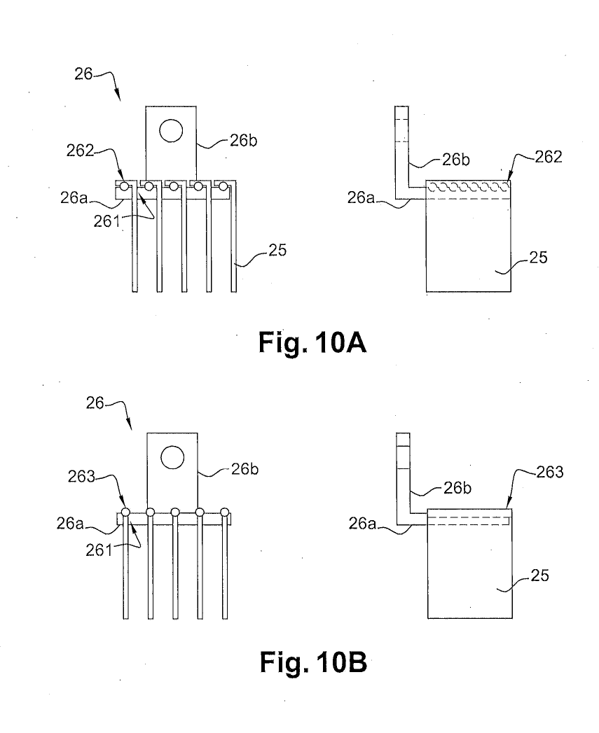

FIGS. 10A and 10B represent two modes for fixing the positive connector 26 on the connecting straps 25 of the positive electrode.

According to a first mode represented in FIG. 10A, the straps 25 of the positive electrode are inserted into the slits 261 of the connector 26, then folded so that their free end is pressed against the surface of the portion 26a. Then, each end of strap 25 is fixed to the portion 26a of the connector by means of several resistance welding points 262 spread out along each slit 261.

According to a second mode represented in FIG. 10B, the straps 25 are inserted into the slits 261, then trimmed so that they do not extend beyond the surface of the portion 26a. Then, each strap 25 is welded to the portion 26a of the titanium connector over the whole length of the edge inserted into the slits 261. This welding is carried out using a laser under an atmosphere comprising a protective gas, for example argon.

These two welding techniques, resistance spot welding and laser welding, are rapid and inexpensive, notably thanks to the fact that they may be automated or semi-automated.

In the example of FIGS. 7 and 9, the portion 16a of the negative connector 16 and the portion 26a of the positive connector 26 have a trapezoidal shape suited to connecting straps of variable length. This shape is thus more particularly suited to the connecting straps of the spiral accumulator (cf. FIGS. 3A-3B). Alternatively, the portions 16a and 26a may have a rectangular shape, more suited to connecting straps of same length (the slits 261 of the connector 26 are in this case of same length).

Unlike connectors of the prior art, the connectors 16 and 26 of FIGS. 7 to 10 are designed to only occupy a portion of the upper face of the accumulator (FIGS. 3B and 5). Their negative impact on the specific energy and the specific power of the accumulator is thus limited. Obviously other shapes of connectors 16 and 26 than those represented in FIGS. 7 and 9 may be envisaged. For example, the outer edge of the portions of connector 16a and 26a may be rounded, rather than straight, and thus coincide with the cylindrical case of the spiral accumulator.

A method for manufacturing a lead accumulator according to the invention will now be described. This method comprises the following steps:
the formation of a negative electrode from a carbon sheet (FIG. 1);
the formation of a positive electrode from a titanium sheet (FIG. 2); and
the assembly of the negative and positive electrodes with at least one sheet of insulating and porous material separating them, for example in a spiral (FIG. 3A-3B) or prismatic shaped (FIG. 5).

To form the negative electrode 1 of FIG. 1, a lead-based layer (layers 11a-11b) and a layer of lead-containing active material (layers 12a-12b) are successively deposited on each of the two faces 10a and 10b of the carbon sheet 10.

The lead-based layers 11a and 11b may be formed by electrodeposition of lead or a lead alloy on the surface of the carbon current collector, for example by applying the operating conditions described in the patent EP2313353. Optionally, copper layers 14a and 14b are electrodeposited on the surface of the carbon sheet 10, before the deposition of the lead-based layers 11a and 11b, according to an operating procedure also described in this document.

Advantageously, the carbon sheet 10 undergoes, prior to the deposition of the lead layers 11a and 11b, a treatment aiming to increase its surface roughness. In fact, high roughness guarantees a better hold of the lead-based layers 11a and 11b. This treatment may be carried out mechanically, by polishing, brushing or sanding, chemically by thermal treatment under oxygen or by immersion in an oxidising solution, or electrochemically by anodic etching (by immersing the carbon sheet in an electrolyte and by applying a positive potential).

Then, a paste of negative active material (NAM) is spread out on each of the faces of the carbon sheet covered with lead (this step is known as “pasting”). The NAM paste contains, preferably, lead oxide (PbO), water, sulphuric acid and one (or more) additive(s), known as “expanders” and formed from lignosulfonates, BaSO₄ or fine carbon particles.

Finally, the carbon sheet covered with layers of paste 12a-12b may be laminated with the two sheets of paper 13a and 13b made of glass fibers or cellulose-based fibers.

The layers of paste 12a and 12b having a low viscosity may be partially dried before the step of laminating the sheets of paper 13a-13b. For a paste of high viscosity, such a drying step is not necessary, because the sheets of paper 13a and 13b absorb the excess humidity in the paste. The pastes of active material are thixotropic mixtures of which the viscosity depends on the mixing speed, comprised between 0.5 and 5 revolutions/s, for example 1 revolution/s.

The formation of the positive electrode 2 comprises successively, on each of the faces 20a-20b of the titanium sheet 20 (FIG. 2), the deposition of a semiconductor metal oxide layer (layers 21a-21b), then potentially the deposition of a dense layer of lead oxide PbO₂ (layers 24a-24b) and finally the deposition of a layer of lead-containing active material (layers 22a-22b).

Preferably, the titanium sheet 20 is treated to increase its surface roughness, before receiving the semiconductor metal oxide layers 21a-21b. This treatment may be carried out mechanically, by sanding or brushing, and/or chemically by immersion in a hydrochloric acid or oxalic acid solution (for example for 2 min to 5 min in a boiling 10% hydrochloric acid solution or for 30 min to 60 min in a boiling 10-15% oxalic acid solution).

The deposition of semiconductor metal oxide layers 21a-21b may be carried out in different ways, notably by spray-pyrolysis. As an example, the solution sprayed onto the substrate (heated to 400-500° C.) contains a 0.5 mol/L solution of SnCl₂, a 0.05 mol/L solution of SbCl₃ and a 0.1 mol/L solution of HCl in an ethanol and water mixture (40% ethanol, 60% water).

The layers 24a-24b of lead oxide PbO₂ are, preferably, formed by electrodeposition, by mixing in the galvanic bath a source of dopants, for example NaF for fluorine doping. As an example, the galvanic bath comprises a 0.1˜1 mol/L solution of lead (II) methanesulphonate, a 0.1˜0.2 mol/L solution of methane sulphonic acid, a 0.05 mol/L solution containing a cetrimonium salt (cetrimonium bromide, chloride or tosylate) and a 0.01 mol/L NaF solution.

These three preliminary preparation steps of the titanium current collector prevent the formation of a superficial and highly resistant titanium oxide TiO₂, before the application of the layers of paste of positive active material (PAM). The paste of PAM conventionally comprises lead oxide (PbO), water and sulphuric acid. It is spread out on the two faces of the titanium sheet covered with layers of SnO₂ and PbO₂, for example by scraper.

Finally, two sheets of paper 23a and 23b made of glass fibers or cellulose-based fibers are advantageously laminated on the two layers of paste of active material 22a and 22b.

During the step of pasting of the electrodes, an edge of the carbon sheet and an edge of the titanium sheet are not covered with the paste of active material. These edges are intended to form the connecting straps of each electrode.

Advantageously, the negative and positive electrodes have the shape of long continuous and flexible strips and are manufactured according to a “roll-to-roll” method, from a current collecting sheet (for example made of carbon or titanium) stored in the form of a reel. This type of method is particularly well suited to the formation of thin layer battery electrodes and makes it possible to attain high production efficiency.

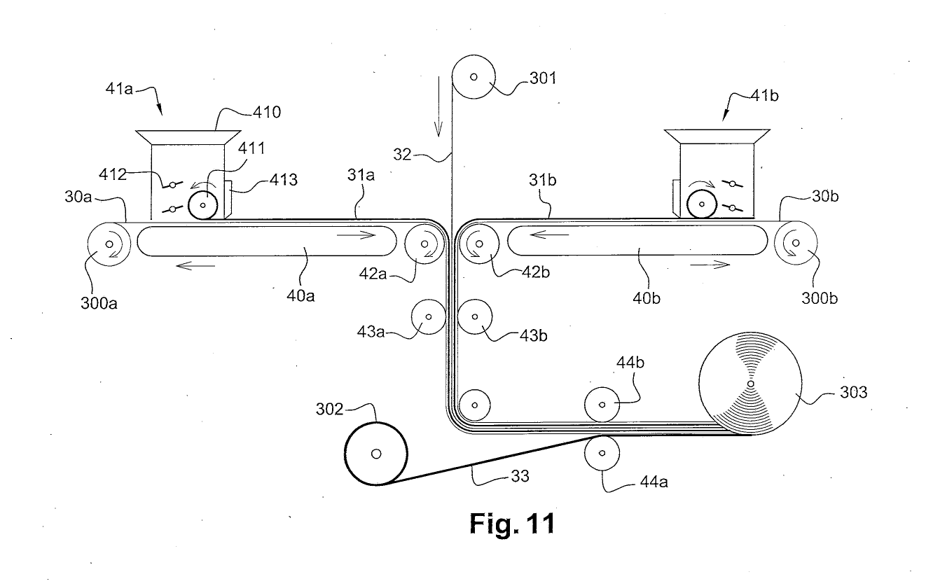

FIG. 11 represents a preferential embodiment of this method for manufacturing an electrode, in which a sheet of paper, serving as support to the active material of the electrode, is transferred onto each of the faces of the current collecting sheet.

Two sheets of paper 30a and 30b are, independently of each other, coated with a paste of active material (PAM or NAM depending on the nature of the electrode to be manufactured). The paper of the sheets 30a and 30b is commonly called pasting paper, because it is suited to the deposition of a paste of active material. It is, preferably, formed from glass fibers, with a structure identical to that of AGM separators used in lead batteries. Alternatively, it may be formed from fibers of a material other than glass (cellulose, polyester) or a mixture of glass fibers and fibers of this other material. The sheets of paper 30a and 30b have, preferably, a thickness comprised between 50 μm and 200 μm.

The steps of pasting of the sheets of paper 30a and 30b are, preferably, carried out simultaneously by means of two belt pasting, machines. Thus, the sheets 30a and 30b in the form of strips are each carried by a belt conveyor during the deposition of the paste of active material. The strip of paper 30a, coming from a roll 300a, is driven by a belt conveyor 40a and covered with a layer of paste 31a, by means of a coating device 41a. In the same way, the strip of paper 30b, coming from the roll 300b, is driven by a belt conveyor 40b and covered with a layer of paste 31b, by means of a coating device 41b. The movement of the belts 40a-40b has the effect of unrolling progressively the rolls of paper 300a-300b. The layers of paste 31a and 31b have, preferably, a thickness comprised between 100 μm and 500 μm.

The sheets of paper 30a and 30b are then bonded onto either side of the current collecting sheet 32, by means of the paste of active material. In other words, the layers 31a and 31b play the role of adhesive to fix respectively the sheet of paper 30a onto a first face of the sheet 32 and the sheet of paper 30b onto an opposite second face of the sheet 32. Pressure may be exerted on the sheets of paper 30a-30b in order to reinforce this bonding, for example by making the sheets 30a, 30b and 32 pass between two calendaring cylinders 42a-42b. The cylinders 42a-42b turn in opposite senses.

Advantageously, the sheets of paper 30a-30b are (on one side only) entirely covered with paste of active material and have a width less than that of the current collecting sheet 32. Thus, an edge of the sheet 32 is free of paste of active material (on the two sides) and will serve to form the connecting straps of the electrode.

The current collecting sheet 32 may be formed from different materials and potentially covered with adhesion and/or anticorrosion layers. Its thickness is, preferably; comprised between 20 μm and 200 μm. For example, in the case of an electrode for lead accumulator, the sheet 32 is advantageously made of carbon (negative electrode) or titanium (positive electrode), and the paste of active material contains lead.

In the preferential embodiment represented in FIG. 11, the current collecting sheet 32 is a continuous and flexible strip, coming from a reel 301 and oriented vertically. The sheets of paper 30a-30b covered with paste are brought into contact with the sheet 32, along a direction perpendicular to the sheet 32. This layout makes it possible to exert an identical pressure on either side of the sheet 32. Thus, the layers of paste 31a and 31b have after bonding substantially the same thickness.

The sheets of paper 30a-30b thus move in the direction of the sheet 32 in opposite senses. The speed of movement of the sheet 30a on the conveyor 40a is, preferably, equal to that of the sheet 30b on the conveyor 40b and comprised between 5 cm/s and 1 m/s, advantageously between 5 cm/s and 50 cm/s. The sheet 32 is driven at the same speed of movement by the strips of paper 30a and 30b.

After the bonding operation, the stack of sheets 30a-31a-32-31b-30b constitutes a multilayer electrode strip, ready for assembly in an accumulator. This stack is advantageously laminated, by making it pass between another pair of cylinders 43a-43b arranged on either side of the current collecting sheet 32. This operation is conducted if it is wished to reduce the thickness of the electrode strip, for example when the pressure exerted by the cylinders 42a-42b is not sufficient to reach the desired thickness. Thus, it is possible to adjust more easily the thickness of the electrode and perfect the adhesion between the different layers of the stack.

Another optional step of the manufacturing method consists in bonding against the multilayer strip of electrode a separator sheet 33, in preparation for the assembly of the positive and negative electrodes of the accumulator. The separator sheet 33 is, preferably, a strip of AGM type coming from a roll 302. It is pressed against the electrode strip by means of a pair of calendaring cylinders 44a-44b.

To facilitate its conditioning, the electrode strip (with or without AGM separator 33) may be also wound into a reel 303 immediately after its manufacture.

Once the reel of electrode 303 is blocked or immobilised, it may be wound with an adhesive, then placed in an oven at 60-120° C. for 12-24 hours in order to dry and cure the paste of active material.

This method of electrode manufacture makes it possible to deposit, rapidly and with good precision (+/−50 μm), two layers of paste of active material on either side of a current collecting sheet. Thus, it is possible to produce in large quantity and at lower cost electrodes for large capacity batteries, having a total thickness comprised between 100 μm and 1000 μm, and preferably between 200 μm and 600 μm.

Using the sheets of pasting paper as support for the paste of active material, rather than the current collector, makes the step of pasting easier and enables better control of the thickness of the active material layers. Thus, compared to methods for manufacturing electrodes of the prior art, notably that described in U.S. Pat. No. 4,606,982, it is easier to attain layers of paste of identical thickness on the two sides of the current collector, and thus to obtain better use of active material. Finally, the fact of working simultaneously with the two faces of the electrode enables a gain in terms of productivity.

In FIG. 11, each coating device 41a-41b comprises a paste reservoir 410, a spreading cylinder 411 and at least one mixer 412 arranged in the reservoir 410. Moreover, a scraper 413 is arranged at the outlet of the coating device to adjust the thickness of the layer of paste deposited on the moving sheet of paper. The paste of active material is thus, in this embodiment of the pasting step, spread on each of the sheets of paper 30a and 30b by means of the spreading cylinder 411 and smoothed out using the scraper 413.

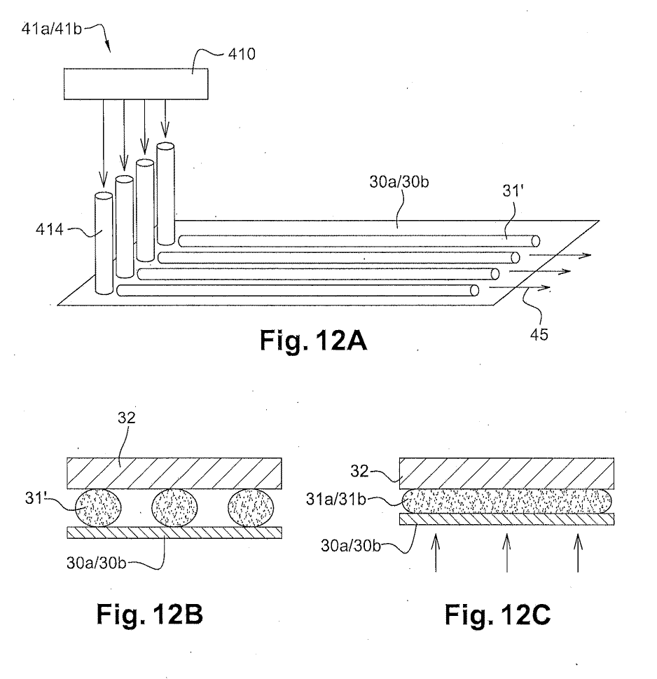

In an alternative embodiment represented in FIGS. 12A to 12C, the paste of active material is deposited on the sheets of pasting paper 30a-30b in the form of rectilinear beads 31′. The coating devices 41a-41b comprise to this end a plurality of coating nozzles 414, instead of the spreading cylinder 411 and the scraper 413. Preferably, the nozzles 414 are aligned perpendicularly to the direction of movement of the strips of paper 30a-30b, symbolised by the arrows 45, such that the beads of paste 31′ are parallel with each other. The nozzles 414 are supplied with paste of active material by the reservoir 410.

During the step of bonding the sheets of paper 30a-30b onto the collector 32, pressure is exerted on each sheet of paper (by means of the calendaring cylinders 42a-42b) (cf. FIGS. 12B-12C). Then, the beads of paste 31′ are spread out and join up to form the layers of paste 31a-31b.

This alternative embodiment is more suited to high viscosity pastes than the so-called “doctor blade” method represented in FIG. 11. Since the running speed of the sheets of paper 30a-30b and the flows of paste in the nozzles 414 are constant, it is possible to control precisely the load of paste (i.e. the grammage per surface unit) deposited on each sheet. Moreover, this technique makes it possible to interrupt more easily, that is to say at any moment, the deposition of paste of active material. This is particularly advantageous when it is wished that an end of the sheets of paper, and thus the strip of electrode, is not covered with paste. For example, in an assembly of spiral shaped electrodes (cf. FIG. 3A), it is pointless to deposit material on the face of the electrode turned towards the outside of the winding, because this surface (belonging to the positive electrode 2 in the example represented) is facing the cylindrical case (not represented) of the accumulator, rather than the electrode of opposite polarity. The active material on this surface would not participate in electrochemical reactions. It is thus advisable not to deposit any of said material, for reasons of economy and in order not to make the spiral accumulator needlessly heavy.

The step of assembly of the positive and negative electrodes consists in pressing the electrodes against each other, separating them by at least one sheet of porous and electrically insulating material, and shaping the stack that results from this pressing together, for example by folding, cutting, winding, etc. During this assembly step, it is also possible to shape the connection elements of the electrode. All of these operations may furthermore be carried out within a same assembly equipment.

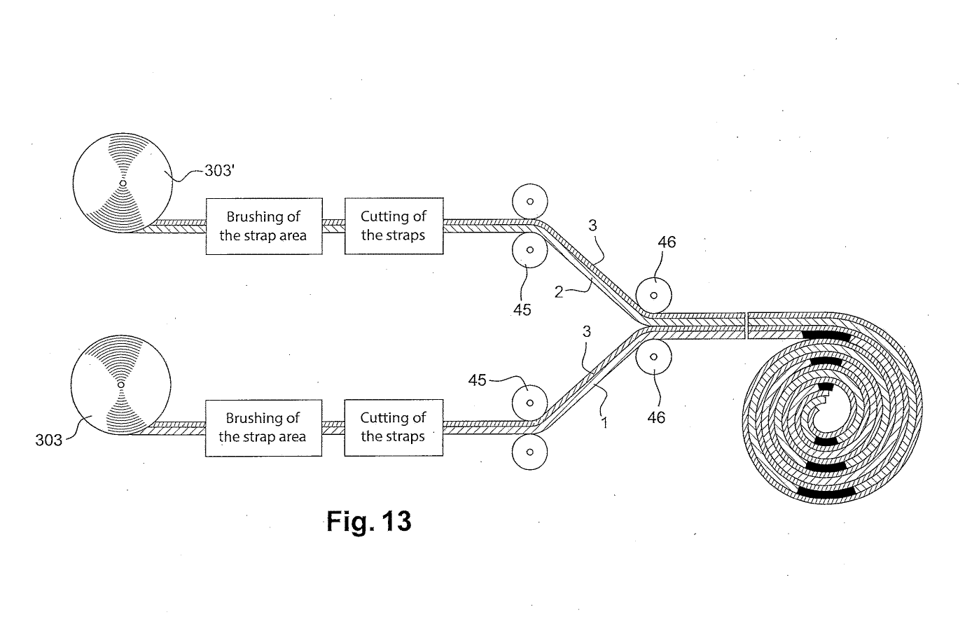

FIG. 13 represents a preferential embodiment of the step of assembly of a spiral accumulator, wherein the negative electrode 1 and the positive electrode 2 have the shape of continuous and flexible strips, supplied respectively by storage reels 303 and 303′.

The reels 303 and 303′, which are loaded in the equipment, each contain a winding of a single electrode, positive or negative. For example, the lower reel 303 contains the strip of negative electrode 1, whereas the upper reel 303′ contains the strip of positive electrode 2. The reel 303 of negative electrode and the reel 303′ of positive electrode have, preferably, been produced in the course of the step of FIG. 11.

A separator sheet 3 is bonded to each electrode, by means of the active material of the electrode. This bonding may have been carried out immediately after the manufacture of the electrode, as has been mentioned previously in relation with FIG. 11. The separator sheets 3 are then contained in the reels 303 and 303′. An alternative consists in supplying four reels (instead of two): two reels containing uniquely the strips of positive and negative electrode and two additional reels for the separator sheets. The four reels are unwound simultaneously two by two, each separator sheet being laminated onto an electrode strip.

As the reels 303 and 303′ are unwound, the electrode strips 1 and 2 progress in the assembly machine and are treated in parallel with each other. This treatment notably comprises the brushing and the cutting up of portions of electrode free of active material, to form connecting straps on each of the electrodes.

Each electrode-separator pairing may potentially pass between a pair of laminating cylinders 45, in order to reduce its thickness.

Then, the electrode strips 1 and 2 are pressed against each other, while interposing between them one of the two sheets 3 of porous material. To do so, the electrode strips 1-2 and their associated separator sheets 3 are introduced between two calendaring cylinders 46.

Finally, the stack of electrodes 1-2 and separator sheets 3 is wound around itself, so as to compress the porous material. During this operation, the porous material of the sheet 3 arranged between the two electrode strips 1-2 is impregnated with positive and negative active materials, which definitively connects the two electrodes. Advantageously, the sheets 3 made of porous material are partially impregnated with water during this step. This makes it possible to reach a high compression level—and thus to extend the lifetime of the accumulator—because the porous material is less elastic when it is wet.

Finally, to preserve the compression of the porous material, the stack may be held firmly wound by an adhesive strip or a plastic film, before being arranged in a cylindrical case.

To assemble a prismatic shaped lead accumulator, it is possible to proceed in an analogous manner with strips of electrode according to a “roll-to-roll” method, except for bonding the two sheets of porous material on either side of a same electrode, for example the negative electrode. Then, rather than pressing the electrodes against each other, the stack of the negative electrode and the separators is folded several times whereas the positive electrode is cut into several portions. Each portion of positive electrode is then arranged under a fold of the stack. The compression of the porous material of the separators takes place when the positive and negative electrodes thus assembled are introduced into the case, this time of rectangular parallelepiped shape.

The electrode manufacturing method of FIGS. 11-12 and the step of assembly of FIG. 13 are of course applicable to the lead accumulator technology described in relation with FIGS. 1 to 6, using notably a titanium collecting sheet for the positive electrode and a carbon collecting sheet for the negative electrode. The titanium collecting sheet may be covered on its two faces with the semiconductor metal oxide layer (SnO₂) and advantageously with the dense layer of lead oxide (PbO₂), as indicated above. Similarly, the carbon collecting sheet may be covered on its two faces with the lead-based layer and advantageously the copper layer.

The assembly of the electrodes is followed by a step of activation of the electrodes, where the paste of NAM and the paste of PAM based on PbO are converted into lead sulphate PbSO₄, after which the accumulator may be used normally (beginning with a formation charge).

It will be noted however that the manufacturing method of FIGS. 11-12 may be used to form other types of electrodes. Among examples of possible batteries may be cited:
Ni-MH with a paste of nickel oxide and suspension based on a pulverulent multi-component alloy;
Ni—Cd with nickel oxide or hydroxide on one side and Cd(OH)₂ on the other
Ni—Zn with nickel oxide or hydroxide on one side and zinc oxide on the other; and
Zn—Ag with pulverulent silver and zinc oxide;

The current collector sheets are made of copper, nickel, steel, lead or aluminium according to the applications.

The method of FIG. 11 also enables the formation of electrodes for supercapacitors, such as C/PbO₂ (“hybrid supercapacitor”) with suspension of carbon and paste based on PbO₂, H₂SO₄ and water.

1. An electrochemical lead-acid accumulator comprising a negative electrode and a positive electrode, wherein the negative electrode comprises:
a current collector formed from a carbon sheet having a thickness comprised between 50 μm and 200 μm;
first and second lead-based layers respectively covering first and second faces of the carbon sheet; and
first and second layers of a lead-containing active material, having a thickness comprised between 100 μm and 500 μm, and arranged on either side of the carbon sheet, respectively on the first and second lead-based layers;
wherein the positive electrode comprises:
a current collector formed from a titanium sheet having a thickness comprised between 50 μm and 250 μm;
first and second electrically conducting metal oxide layers, respectively covering first and second faces of the titanium sheet; and
first and second layers of a lead-containing active material, having a thickness comprised between 100 μm and 500 μm, and arranged on either side of the titanium sheet, respectively on the first and second metal oxide layers.

2. The electrochemical lead-acid accumulator according to claim 1, wherein the negative electrode and the positive electrode are separated by at least one sheet of an electrically insulating porous material and held together in such a way that the porous material is compressed.

3. The electrochemical lead-acid accumulator according to claim 2, wherein the negative electrode, the positive electrode and two sheets of porous material form a multilayer stack, said multilayer stack being wound upon itself to give the accumulator a spiral shape.

4. The electrochemical lead-acid accumulator according to claim 3, wherein the negative and positive electrodes each comprise projecting collector portions not coated with first and second active material layers, the projecting portions of each of the negative and positive electrodes being distributed along a radius of the spiral.

5. The electrochemical lead-acid accumulator according to claim 2, wherein one of the negative and positive electrodes comprises several electrode portions, and wherein two sheets of porous material and the other of the negative and positive electrodes form a multilayer stack, said multilayer stack being folded into a serpentine shape to receive, under each fold, one of the electrode portions.

6. The electrochemical lead-acid accumulator according to claim 5, wherein the negative and positive electrodes each comprise projecting collector portions not coated with first and second active material layers, the projecting portions of the negative electrode being aligned on one side of the serpentine shaped stack and the projecting portions of the positive electrode being aligned on an opposite side of the serpentine shaped stack.

7. Accumulator according to claim 1, wherein the first and second lead-based layers of the negative electrode have a thickness comprised between 10 μm and 20 μm.

8. The electrochemical lead-acid accumulator according to claim 1, wherein the first and second metal oxide layers of the positive electrode have a thickness comprised between 0.5 μm and 2 μm.

9. The electrochemical lead-acid accumulator according to claim 1, wherein each of the first and second active material layers of the negative electrode and of the positive electrode is covered with a sheet of paper made of glass fibers or cellulose-based fibers.

10. The electrochemical lead-acid accumulator according to claim 1, wherein the negative electrode further comprises first and second copper layers arranged on either side of the carbon sheet, between each of the first and second lead-based layers and the carbon sheet.

11. The electrochemical lead-acid accumulator according to claim 1, wherein the positive electrode further comprises first and second lead oxide layers arranged on either side of the titanium sheet, respectively between the first metal oxide layer and the first active material layer, and between the second metal oxide layer and the second active material layer.

12. The electrochemical lead-acid accumulator according to claim 1, further comprising a lead connector electrically connected to a portion of the carbon sheet and a titanium connector electrically connected to a portion of the titanium sheet, the lead and titanium connectors respectively forming the negative and positive terminals of the accumulator.

13. The electrochemical lead-acid accumulator according to claim 12, wherein the lead and titanium connectors occupy only in part a same face of the accumulator.

14. The electrochemical lead-acid accumulator according to claim 1, wherein the carbon sheet is a sheet made of graphite, flexible carbon paper or a carbon fabric.

15. The electrochemical lead-acid accumulator according to claim 1, wherein the titanium sheet is provided with through openings.

16. A method for manufacturing an electrochemical lead-acid accumulator comprising:
forming a negative electrode by depositing successively on each of two faces of a carbon sheet, of thickness comprised between 50 μm and 200 μm, a lead-based layer and a layer of lead-containing active material, of thickness comprised between 100 μm and 500 μm;
forming a positive electrode by depositing successively on each of two faces of a titanium sheet, of thickness comprised between 50 μm and 250 μm, an electrically conducting metal oxide layer and a layer of lead-containing active material, of thickness comprised between 100 μm and 500 μm;
assembling the negative and positive electrodes with at least one sheet of an electrically insulating porous material separating the negative and positive electrodes.

17. The method according to claim 16, wherein the assembly of the negative and positive electrodes comprises:
bonding, by means of the active material, a sheet made of electrically insulating porous material on each of the negative and positive electrodes;
pressing against each other the negative and positive electrodes on which are bonded the sheets made of porous material, so as to form a multilayer stack; and
winding the multilayer stack so as to compress the porous material.

18. The method according to claim 17, wherein the sheets of porous material are partially impregnated with water during the winding of the multilayer stack.

19. The method according to claim 16, wherein the assembly of the negative and positive electrodes comprises:
bonding, by means of the active material, a sheet made of electrically insulating porous material on each of the faces of one of the negative and positive electrodes, resulting in a multilayer stack;
folding the multilayer stack into several areas;
cutting the other of the negative and positive electrodes into a plurality of electrode portions; and
arranging one electrode portion under each fold of the multilayer stack.

20. The method according to claim 16, wherein the negative electrode and the positive electrode are, during the step of assembly, distributed in the form of continuous and flexible strips, driven by rotating cylinders and shaped in parallel with each other.

21. The method according to claim 20, wherein the shaping of the negative and positive electrodes comprises a step of brushing and a step of cutting up a portion of the carbon sheet and a portion of the titanium sheet, so as to form connecting straps on each of the negative and positive electrodes, said portions being free of active material.

22. The method according to claim 16, wherein the formation of each of the negative and positive electrodes comprises:
providing first and second sheets of pasting paper and a current collecting sheet, the current collecting sheet of the negative electrode being constituted of the carbon sheet covered on each of the two faces with the lead-based layer and the current collecting sheet of the positive electrode being constituted of the titanium sheet covered on each of the two faces with the electrically conducting metal oxide layer;
depositing active material on each of the first and second sheets of pasting paper; and
bonding simultaneously, by means of the active material, the first sheet of pasting paper onto a first face of the current collecting sheet and the second sheet of pasting paper onto a second opposite face of the current collecting sheet.

23. The method according to claim 22, wherein the current collecting sheet is in vertically oriented strip form and wherein each of the first and second sheets of pasting paper is brought into contact with the current collecting sheet along a direction perpendicular to the current collecting sheet.

24. The method according to claim 22, wherein the first and second sheets of pasting paper are in strip form, each strip being carried by a belt conveyor during the step of depositing the active material.

25. The method according to claim 24, wherein the first and second sheets of pasting paper move at a speed comprised between 5 cm/s and 1 m/s.

26. The method according to claim 22, wherein the first and second sheets of pasting paper are bonded to the current collecting sheet using two calendaring cylinders exerting a pressure on either side of the current collecting sheet.

27. The method according to claim 22, wherein each of the negative and positive electrodes is moreover laminated by means of two laminating cylinders arranged on either side of the current collecting sheet.

28. The method according to claim 22, wherein the first and second sheets of pasting paper have a thickness comprised between 20 μm and 200 μm.

29. The method according to claim 22, wherein the active material is spread out on each of the first and second sheets of pasting paper by means of a spreading cylinder and smoothed by means of a scraper.

30. The method according to claim 22, wherein the active material is deposited in beads on each of the first and second sheets of pasting paper by means of a plurality of coating nozzles and spread out during the bonding step by pressing said sheet of pasting paper against the current collecting sheet.
